(19) United States
(12) Patent Application Publication
(10) Pub. No.: US 2010/0291418 A1
(43) Pub. Date: Nov. 18, 2010

(54) BATTERY PACKS, SYSTEMS, AND METHODS

(75) Inventors: Peng Zhou, El Cerrito, CA (US); Wei Zhou, Los Altos, CA (US)

Correspondence Address: HAVERSTOCK & OWENS LLP, 162 N WOLFE ROAD, SUNNYVALE, CA, 94086, US

(73) Assignee: SINOELECTRIC POWERTRAIN CORPORATION, Sunnyvale, CA (US)

(21) Appl. No.: 12/779,862

(22) Filed: May 13, 2010

Related U.S. Application Data
(60) Provisional application No. 61/178,635, filed on May 15, 2009.

(51) Int. Cl. H01M 2/10

(52) U.S. Cl. 429/50; 429/153; 429/163; 429/187; 429/96

(57) ABSTRACT

A movable, portable, and instantly attachable/detachable battery pack includes batteries enclosed in a case with a ground transportation structure, such as wheels, coasters, and runners. The battery pack can include handles and mating connectors. The ground transportation structure allows the majority of the weight of the battery packs to be supported by the ground during transportation. The person who moves the battery pack only needs to use a minimum force sufficient to move the battery pack in a direction perpendicular to the force of gravity. Battery packs disclosed herein can be easily maneuvered into a building or structures to be recharged or swapped.

### CROSS-REFERENCE TO RELATED APPLICATIONS

This application claims priority from U.S. Provisional Patent Application Ser. No. 61/178,635, filed May 15, 2009 and entitled “Battery Packs, Systems, and Methods,” which is hereby incorporated herein by reference in its entirety for all purposes.

### FIELD OF THE INVENTION

The present invention relates to batteries for electric vehicles. More specifically, the present invention relates to battery packs that can be easily transported and installed.

### BACKGROUND OF THE INVENTION

Typical electric vehicles are designed to carry bulky battery packs and to be recharged at particular locations. Bulky battery packs are often heavier than necessary, thus unnecessarily adding to the weight of the electric vehicle. Recharging the batteries takes long hours, a wait that can be inconvenient for the electric vehicle users.

Although some battery packs are designed to be removable, they are nevertheless heavy and difficult to be moved to a desired location, such as for recharging or replacement. Owners of electric vehicles will find many advantages with battery systems that can be easily transported for recharging, replacement, and the like.

### SUMMARY OF THE INVENTION

In an aspect, a movable battery pack comprises an electric-vehicle battery pack having a battery enclosure with a ground transporting structure rollable, slidable, or both along a surface. In some embodiments, the battery enclosure and the ground transporting structure are removable as a unit from an electric vehicle. In alternative embodiments, the electric-vehicle battery pack comprises a battery-electric-vehicle battery pack. In other embodiments, the ground transporting structure comprises one or more wheels, coasters, or runners. In alternative embodiments, the ground transporting structure is attached to the battery enclosure. In other embodiments, the electric-vehicle battery pack comprises one or more mating connectors. In some embodiments, the battery enclosure comprises at least one handle. In alternative embodiments, the electric-vehicle battery pack comprises one or more modules of batteries. In other embodiments, the one or more modules comprises one or more cells of batteries. In alternative embodiments, the battery enclosure is configured to fit within a battery compartment of an electric vehicle. In other embodiments, the electric-vehicle battery pack and the ground transporting structure forms an unseparable energy unit.

In a second aspect, an electric vehicle comprises a controller and one or more removable battery packs including a casing adapted to slide or roll along a surface. In some embodiments, the one or more removable battery packs comprise at least one handle. In alternative embodiments, the one or more removable battery packs comprise a mating connector. In other embodiments, the electric vehicle comprises a mating connector. In some embodiments, the mating connector of the electric vehicle is configured to electrically couple with the mating connector of the one or more removable battery packs. In alternative embodiments, the electric vehicle further comprises a securing mechanism for substantially securing the one or more removable battery packs to the electric vehicle. In other embodiments, the securing mechanism couples with a mating connector of the electric vehicle, the one or more removable battery packs, or both. In some embodiments, the one or more removable battery packs comprise at least one wheel. In alternative embodiments, the one or more removable battery packs are rechargeable by an AC power source. In other embodiments, the electric vehicle is able to be operated using the energy solely from one of the one or more removable battery packs.

In a third aspect, a method of using an electric-vehicle battery pack comprises rolling, sliding, or both one or more ground transporting elements of an electric-vehicle battery pack along a surface and electrically coupling the electric-vehicle battery pack with an energy device. In some embodiments, the one or more ground transporting elements comprise one or more wheels. In alternative embodiments, the surface comprises a ground surface. In other embodiments, the energy device comprises an electric vehicle, an electrical charger or both. In some embodiments, the electrically coupling comprising coupling a mating connector of the electric-vehicle battery pack with a mating connector of the electric vehicle. In alternative embodiments, the rolling, sliding, or both are performed by holding at least one handle of the electric-vehicle battery pack. In other embodiments, the method further comprises disengaging the electric-vehicle battery pack from the energy device. In some embodiments, the method further comprises removing the electric-vehicle battery pack from the energy device. In alternative embodiments, at least one of the ground transporting elements touch a ground surface when the ground transporting elements is transported. In other embodiments, the method further comprises recharging the electric-vehicle battery pack. In some embodiments, the recharging is performed by using an AC power source.

### BRIEF DESCRIPTION OF THE DRAWINGS

FIG. 1 is a top view and side view of an electric vehicle (EV) and a movable battery pack, respectively, in accordance with some embodiments of the present invention.

FIG. 2 shows a connection between a battery pack and an electric vehicle in accordance with some embodiments of the present invention.

FIG. 3 shows a battery pack during transportation and a compartment in an EV, both with and without the battery pack, in accordance with some embodiments of the present invention.

FIG. 4 is a flowchart illustrating a method of electric vehicle battery pack usage in accordance with some embodiments of the present invention.

FIG. 5 shows an illustrative battery pack usage scheme 500 in accordance with some embodiments of the present invention.

### DETAILED DESCRIPTION OF THE INVENTION

A movable, portable, and easily attachable/detachable battery pack includes one or more batteries enclosed in a case having a ground transportation structure. In some embodiments, the ground transportation structure contains one or more wheels. Because most of its weight rests on the ground during movement, the battery pack can be moved easily, with little force. Battery packs in accordance with some embodiments of the present invention can be easily maneuvered for recharging or replacement. The battery pack disclosed herein can be transported among various locations, such as an EV, a docking recharging location, and storage, without the need to physically lift the battery pack.

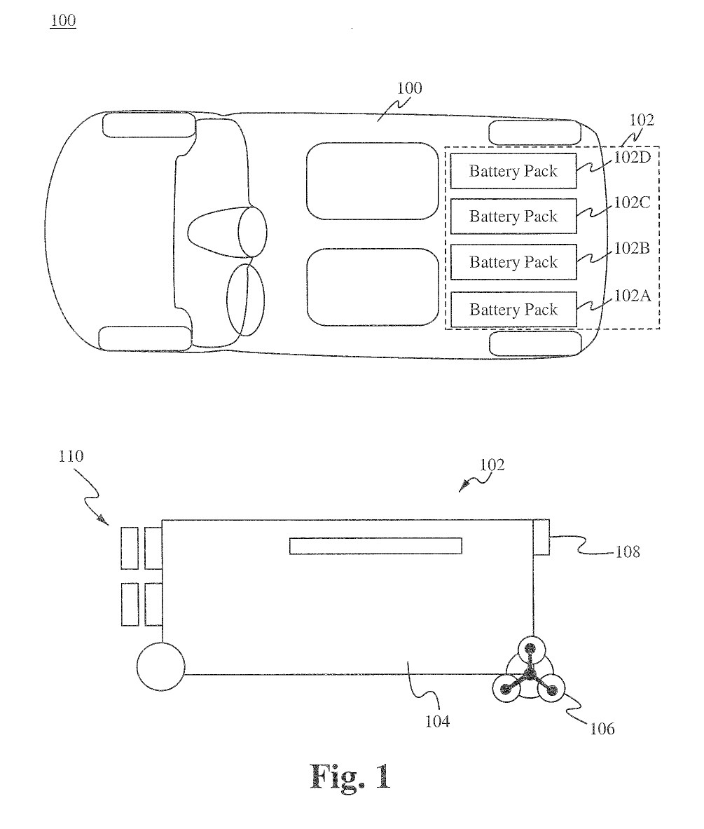

FIG. 1 illustrates an electric vehicle (EV) 100 and a movable battery pack 102 in accordance with some embodiments of the present invention. In some embodiments, the electric vehicle 100 is a battery electric vehicle (BEV). The electric vehicle 100 is able to contain one or more battery packs 102. The one or more battery packs 102 are able to function independently or jointly. In some embodiments, each of the battery packs 102 includes at least one handle 108, a battery pack enclosure or housing 104, one or more wheels 106, and one or more mating connectors 110.

The one or more battery packs 102 on the electric vehicle 100 can be operated concurrently and/or independently. In some embodiments, the electric vehicle 100 contains battery packs 102A, 102B, 102C, and 102D. The battery packs 102A-102D can form a battery pack assembly 102. In alternative embodiments, the electric vehicle 100 contains battery packs 102A and 102B. In other embodiments, the electric vehicle 100 contains single battery pack 102A. In the case when the electric vehicle 100 is designed to have multiple battery packs, such as 102A and 102B, the electric vehicle 100 is able to be operated when only one is installed. Alternatively, the electric vehicle 100 is able to operate using multiple battery packs at the same time. For example, the electric vehicle 100 can draw half of its operating electricity from battery pack 102A and the other half from the battery pack 102B. In another example, the electric vehicle 100 can draw 70% electricity from the battery pack 102A, 20% from the battery pack 102B, and 10% from other sources, such as a solar panel. The source and amount of electricity drawn can be controlled by an additional computer chip or by the nature of the battery properties, such as the remaining amount or relative amount of electricity in the battery packs 102A-D.

In some embodiments, each of the battery packs 102A-D is 22 kg. In alternative embodiments, the battery pack 102 has a weight ranging from 10 kg to 50 kg. In other embodiments, the battery pack, for example 102A, has a weight ranging from 1 kg to 100 kg. In some embodiments, the battery pack, for example 102A, has an electricity capacity of 3.5 kWh (Kilowatt-Hour). In alternative embodiments, the battery pack assembly102 has an electricity capacity sufficient for average daily use of an electrical vehicle. The electrical vehicle 100 can be any type of transportation vehicle, including a sedan, a coupe, a Jeep, a bus, or a train. In other embodiments, any one of the battery packs 102A-D is able to power a 600 kg car for 100 km, which is sufficient for daily driving needs. In some embodiments, each of the battery packs 102A-D has a physical dimension similar to half of a suitcase, such as 100 cm×50 cm×50 cm. In some embodiments, the battery pack, for example battery pack 102A, contains one or more battery modules. Each of the battery modules can contain one or more cells of batteries, such as 20×18 cells or 20×100 cells. In some embodiments, the batteries are lithium-ion batteries. A person who has ordinary skill in the art would appreciate that other types of batteries and any number of cells can be used. For example, the batteries can be nickle, lithium, or cadmium-based batteries.

The handle 108 is able to be connected to the battery pack enclosure or housing 104. In some embodiments, the handle 108 is fixed on one side of the battery pack enclosure or housing 104. A person who has ordinary skill in the art would appreciate that the handle 108 is able to be fixed on any side of the battery pack enclosure or housing 104. The handle can be fixed in various ways. As some examples, the handle 108 is glued on the battery pack enclosure or housing 104, screwed onto the battery pack enclosure or housing 104, or secured by other methods, whether physical, mechanical, or chemical.

In different embodiments, the handle 108 comprises a fixed length frame; a retractable handle, so that the length of the handle is adjustable; a foldable handle, so that the handle is able to be folded to save space or to fit within a limited space in a compartment of a vehicle. In some embodiments, the handle contains the mating connectors 110, so the handle is able to be plugged into or connected with a power/electricity receiving part of the electric vehicle and/or a recharging facility. In some transportation methods disclosed herein, an operator or mover of the battery pack is able to hold onto the handles 108 transporting the battery packs 102 having the one or more wheels 106 touching the ground, so the weight of the battery packs 102 are substantially supported by the ground. As such, the operator or mover is able to easily maneuver or drag the battery packs 102 to a destination with a force sufficient to overcome the friction caused by the weight of the battery pack 102 between the wheels and the contacting ground. A person who has ordinary skill in the art would appreciate that different materials/sloops/patterns of the ground will result in different frictions or anti-moving barriers, so the operator or mover must exert difference forces to overcome such frictions or barriers.

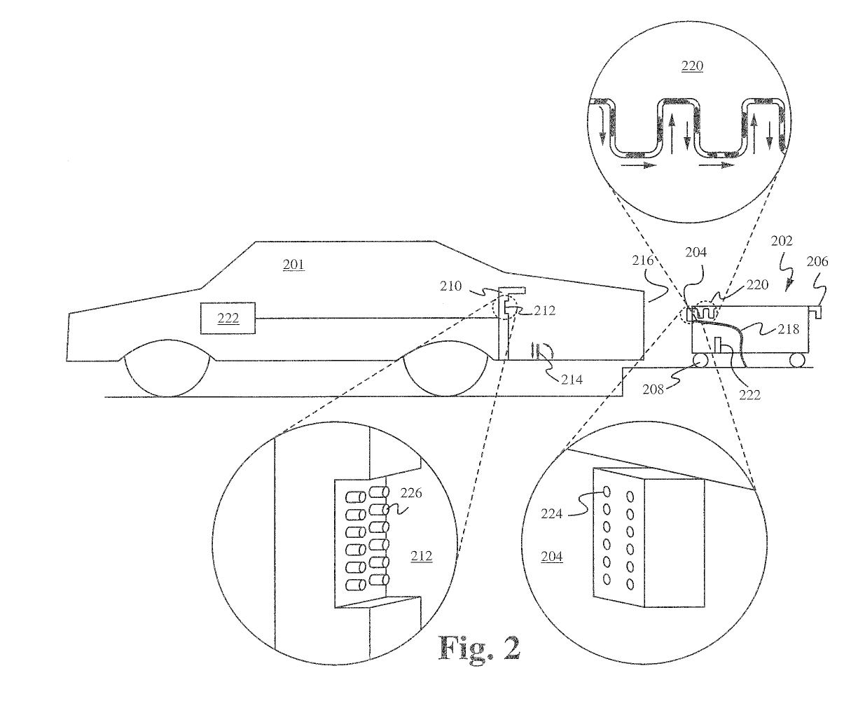

Still referring to FIG. 1, the mating connectors 110 are able to provide a mechanical interface, thermal interface, electrical interface, or combination thereof between the battery packs 102 and the electric vehicle 100. The mating connectors 110 can comprise various mechanical connecting mechanisms, so the battery packages 102A-D can mechanically connect to or secure to the electric vehicle 100. Further, the mating connectors 110 can comprise electric connecting mechanisms, such as high-voltage and/or low-voltage pathways, so that the electric vehicle 100 can receive desired voltage and/or current from the battery packs 102A-D. Moreover, the battery packs 102A-D can comprise various components, such as electric grounding components and cooling components. Each of the battery packs 102A-D is able to include at least one handle 108, a battery pack enclosure or housing 104, one or more wheels 106, and one or more mating connectors 110. In some embodiments, the battery packs 102A-D can form a battery pack assembly 102. The battery pack assembly 102 has an enclosure having battery packs 102A-D within the enclosure. At least one of the wheels 106, at least one of the handles 108, and/or at least one of the mating connectors 110 are attached to the enclosure. Accordingly, the battery packs 102A-D can be moved together as one assembly unit. In some embodiments, each of the battery packs 102A-D is able to include at least one connectable handle, a connectable battery pack enclosure or housing 104, one or more connectable wheels 106, and one or more connectable mating connectors 110. The various connectable components make any of the battery packs connectable with the rest of the other battery packs. For example, the battery pack 102A can have a connectable handle that is able to be connected with the handle of the battery pack 102B, so that the battery packs 102A and 102B are connected to form a movable unit. Some examples of the mating connectors 110 is illustrated in FIG. 2.

FIG. 2 shows a graphic illustration of the connection between a battery pack 202 and an electric vehicle 201 in accordance with some embodiments of the present invention. The electric vehicle 201 comprises a controller 222 electrically coupled to a receiver part 210 to couple to the battery pack. The battery pack receiving part 210 contains a mating connector receiving port 212. The electric vehicle 201 also contains a door 216 for inserting and removing the battery pack 202 from the electric vehicle 201. A pin 214 is on the electric vehicle 201 to secure or lock the battery pack 202 by engaging the pin 214 to a pin receiving part 222 on the battery pack 202 when installed. The battery pack 202 comprises a mating connector 204, wheels 208, pin receiving part 222, cooling component 220, grounding strip 218, and handle 206. In some embodiments, the mating connector 204 comprises one or more mounting holes 224 on each battery pack and the mating receiving port 212 comprises mounting pins 226. In some embodiments, the pattern of the arrangement of the mounting holes 224 matches the pattern of the arrangement of the mounting pins 226, so that the connection between the mounting holes 224 and the mounting pins 226 can only be performed in one or more predetermined directions. In alternative embodiments, the mounting holes 224 and the mounting pins 226 are designed to be connected in more flexible and easily accessible ways, such as by using various types of ball joints. In some embodiments, bolts and nuts are able to be used to mechanically secure and/or lock the battery pack 202 with the battery receiving part 210 of the electric vehicle 201. In other embodiments, the mating connector 204 of the battery pack 202 and/or the electric vehicle 201 comprises one or more latching mechanisms, so that the battery pack 202 and the electric vehicle 201 are able to be mechanically secured or connected to each other. A person who has ordinary skill in the art would appreciate that the battery pack 202 is able to be mechanically connected to the electric vehicle 201 in various ways. For example, the mounting pins 226 are able to be on the battery pack 202 and the mounting holes 224 are able to be on the battery receiving part 210.

The mating connector 204 is able to act as an electrical interface between the battery pack 202 and the electric vehicle 201. In some embodiments, the mating connector 204 comprises one or more sets of high voltage connectors on the battery pack 202 and/or the electric vehicle 201 to provide high voltage, such as 320V, and/or high current path for the battery packs 202 to discharge or charge. In alternative embodiments, the mating connector 204 comprises one or more sets of low voltage connectors on the battery pack 202 and/or the electric vehicle 201 to provide low voltage, such as 12V, and/or low current path for the battery pack 202 to discharge or charge. In other embodiments, the mating connectors 204 comprises one or more sets of high voltage interlock loop connectors to determine the conductivity between the enclosures of the battery pack 202 to the electric vehicle 201. In some embodiments, the mating connectors 204 comprise one or more connectors to provide control signals to and to receive information from the battery pack 202. Various ways of electrical and electronic signal communications are able to be performed between the battery pack 202 and the electric vehicle 201. A person who has ordinary skill in the art would appreciate that any electronic controlling, detecting, sensing, communicating devices are able to be used to exchange voltage and control signals between the electric vehicle 201 and the battery pack 202. For example, a wireless device is able to be included on the battery pack 202 and/or the electric vehicle 201, so the usage and remaining amount of the electricity in the battery pack 202 are able to be monitored and controlled in a remote control center.

In some embodiments, the mating connector 204 includes one or more sets of group straps 218 to ground the enclosure of the battery pack 202 to the chassis of the electric vehicle 201. In alternative embodiments, the mating connector 204 comprises one or more coolant connectors 220 to provide coolant flow to remove heat from the battery pack 202. In some embodiments, the mating connector 204 includes one or more sets of matching air ducts to provide air flow to cool and/or heating wires to heat the battery packs 202A-D.

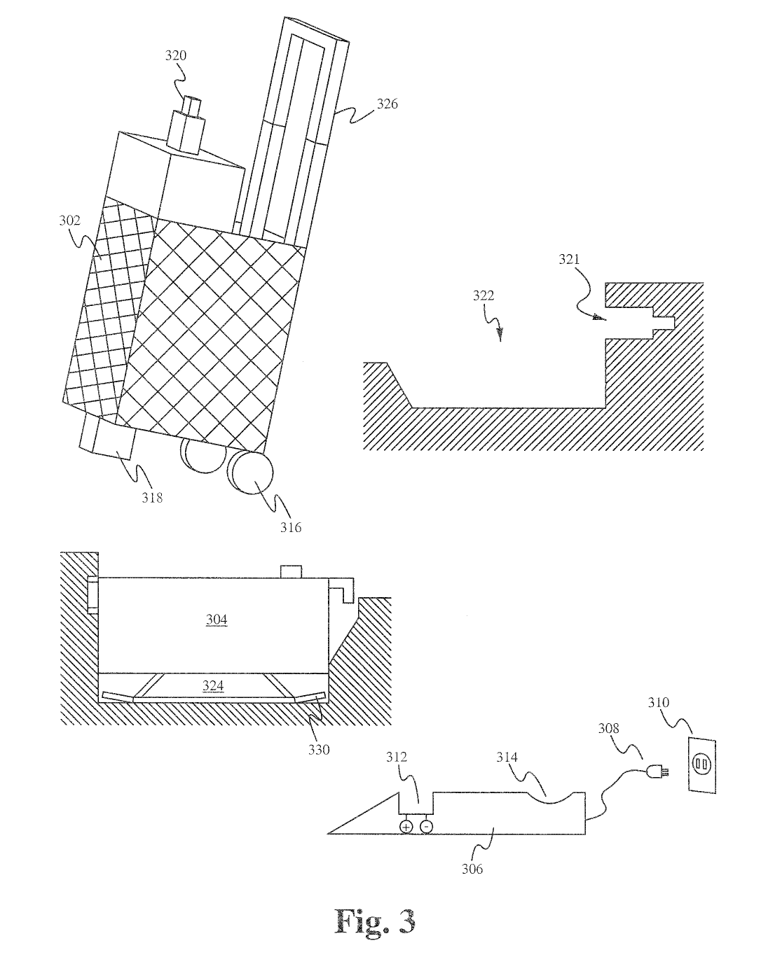

FIG. 3 shows a graphic illustration of the uses of battery packs 302 and 304 in accordance with some embodiments of the present invention. In some embodiments, electric vehicles comprise a compartment 322 or 324 for accommodating the battery packs 302 and 304. The compartments 322 and 324 are able to be designed to fit the shapes of the battery pack 302 and 304. Alternatively, the battery pack 302 can be designed to fit into the compartments 322 and 324. For example, the compartment 322 can has a receiver space 321 that can be used to fit the mating connector 320 on the battery pack 302. The handle 326 of the battery pack 302 can be retractable and can be completely retracted into the main body of the enclosure of the battery pack 302, so that the handle 326 does not get in the way for the body of the battery pack 302 to fit into the compartment 322. In some embodiments, the battery pack 302 is able to be recharged using a docking station 306. The battery pack 302 is able to be removed from the compartment 322 of an electric vehicle and to be transported by rolling on the one or more wheels 316. Similarly, the battery pack 304 is able to use a ground transporting structure 330, such as coasters and runners, for transportation. The battery pack 302 is able to be brought to the docking station 306 for a recharge. In some embodiments, the mating connector 318 electrically couples with the recharging port 312 as the wheels 316 rest on the recess 314 for better stability. In some embodiments, the docking station 306 is plugged by using a regular AC power plug 308 into the electrical outlet 310. The docking station 306, the battery pack 302, the electric vehicles, or a combination thereof can contain an AC to DC inverter, DC to AC inverter, and/or a high voltage to a low voltage transformer.

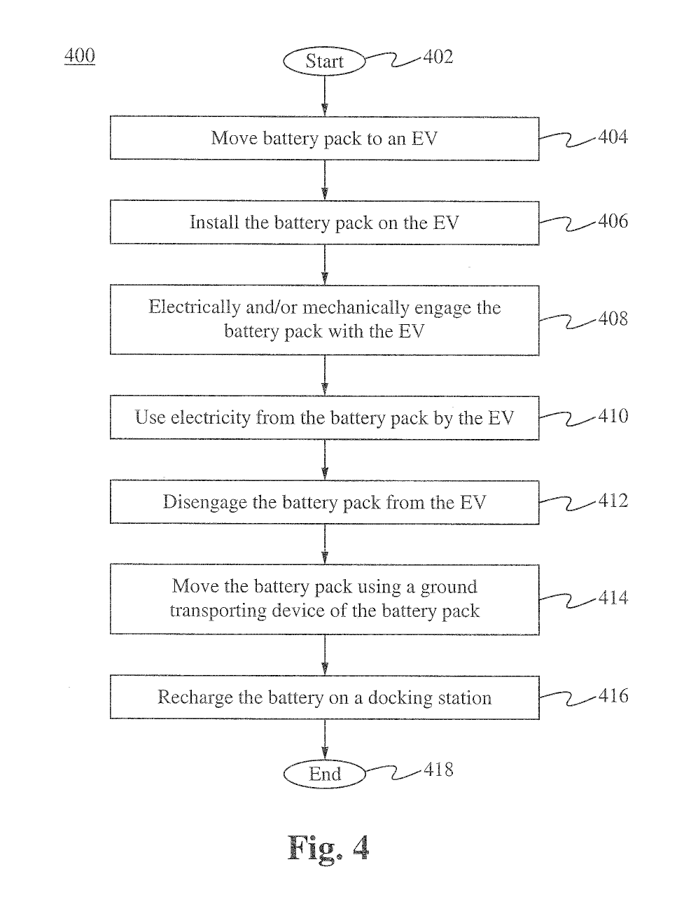

FIG. 4 shows a flowchart illustrating a method 400 of electric vehicle battery pack usage in accordance with some embodiments of the present invention. The method 400 begins from Step 402. At Step 404, the battery pack is moved to an electric vehicle. The moving of the battery pack is able to be performed by using the ground transporting structure, such as one or more wheels. At Step 406, the battery pack is installed on the electric vehicle. The installation of the battery pack can be performed by sliding, rolling, and/or fitting the battery pack into the compartment for batteries in the electric vehicle. At Step 408, the battery pack is electrically and/or mechanically engaged with the electric vehicle. The electrical engagement is able to be performed by connecting the mating connectors with electric conducting material or electrical wires/loops. The mechanical engagement is able to be performed by connecting the mating connectors with securing and/or locking mechanisms with the corresponding locking mechanisms on the electric vehicle. A person who has ordinary skill in the art would appreciate that the battery pack and/or the electric vehicles disclosed herein are able to contain one or more locking mechanisms to secure the positions of the battery packs on the electric vehicle. At Step 410, electricity from the battery pack is received by the electricity vehicle for the power needs of the electric vehicle. At Step 412, the battery pack is disengaged from the electric vehicle. Step 412 is generally performed after the electric vehicle has traveled a distance, during which the battery has discharged. Alternatively, the battery may discharged over time, even with little or no use.

At Step 414, the battery pack is removed from the electric vehicle and is moved to a different location, such as a residential house, recharging station, and/or a storage place. At Step 416, the battery pack is recharged on a recharging docking station. The method of the electric vehicle battery pack usage can end in Step 418. The methods of the electric vehicle battery pack usage, electric vehicle operation, and/or recharging of the battery packs are able to be performed in various ways. In some embodiments, the method of the electric vehicle battery pack usage and/or electric vehicle operation comprises disengaging one or more mating connectors on the one or more battery packs and the mating connectors on the vehicle and removing the battery packs from the vehicle. In alternative embodiments, the method of the electric vehicle battery pack usage comprises installing the battery pack into the vehicle and engaging the mating connectors on the battery packs with the mating connectors on the vehicle. In some embodiments, the method of recharging the battery packs comprises disengaging the mating connectors on the battery packs and the mating connectors on the electric vehicle, removing the battery packs from the vehicle, moving the battery packs by holding onto the handles of the battery packs having the wheels of the battery packs touching the ground, and moving the battery packs to a location for recharging, such as by rolling or sliding.

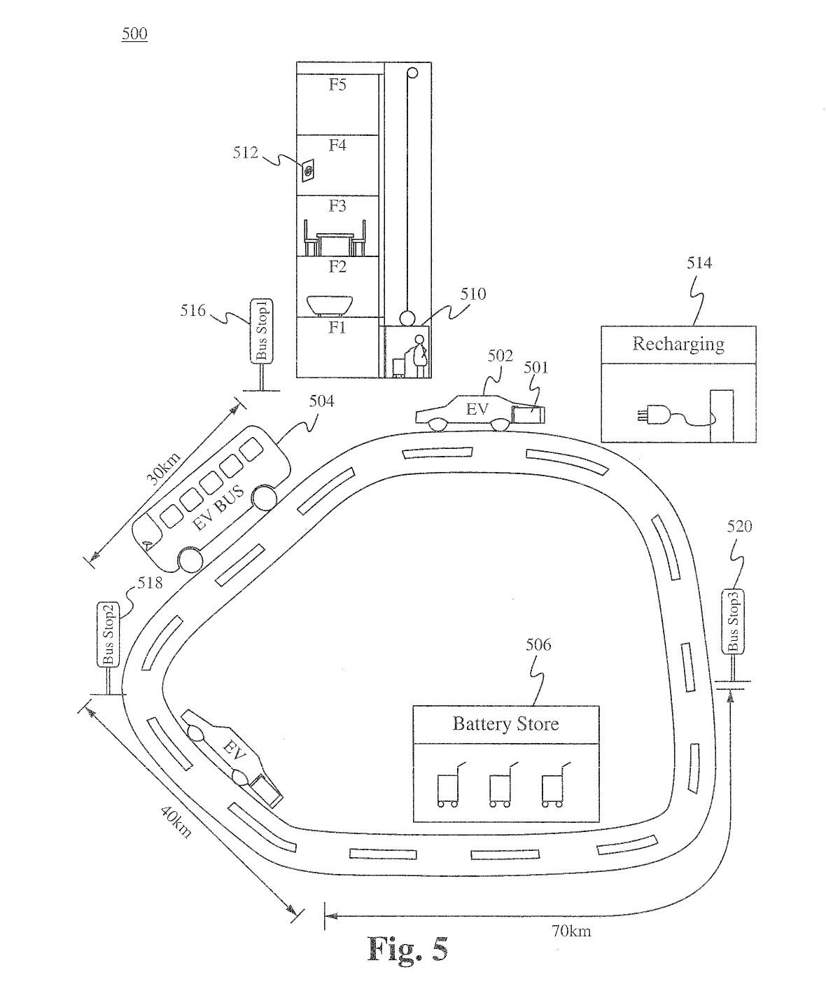

FIG. 5 shows an illustrative battery pack usage scheme 500 in accordance with some embodiments of the present invention. The battery pack 501 with the one or more matching connectors can be instantly attached/detached from the matching connectors of the electric vehicle 502. In some embodiments, the instantly attached/detached function is provided by the male and female plug types of the matching connectors on the battery pack 501 and/or the electric vehicle 502. In alternative embodiments, the locations of the matching connectors on the battery pack 501 and on the electric vehicle 502 are designed to match each other, so the matching connectors on the battery pack 501 and on the electric vehicle 502 are instantly connected when the battery pack 501 is rolled in, pushed in, and/or installed on the battery compartment of the electric vehicle 502. Accordingly, the battery pack 501 is able to be easily disengaged from the electrical and mechanical connections with the electrical vehicle 502. The disengaged battery pack 501 is able to be rolled, slide, or otherwise moved on the ground using the group transporting structure. The substantial weight of the battery pack 501 is supported by the ground, so the user or battery handler is able to easily transport the battery pack 501 between various locations. For example, people living in high rise buildings can easily roll the battery pack 501 into an elevator 510 and to their home to recharge the battery pack 501 at a residential recharge station 512. The capability and convenience of moving the battery pack 501 around facilitate the modern urban lifestyles. The battery pack 501 is able to be recharged, exchanged, or hot swapped in various locations, such as a battery store 506 and a recharging station 514.

Still referring to FIG. 5, the battery pack usage scheme 500 includes uses in electric vehicles having routine and regular routes, such as an electric bus 504. In an example, 5 battery packs 501 are sufficient for the electric bus 504 to travel 50 km. When the bus 504 starts from bus stop one 516, the electric bus 504 can carry 10 battery packs 501 on board. During a first part of the trip, the bus driver selects a first set of 5 battery packs from the 10 battery packs 501 to power the bus 504. The bus driver can switch from the use of the first set of 5 battery packs to a second set of the other 5 battery packs at the bus stop two 518. The switch between the two sets of battery packs can be done manually by switching the matching connectors. Alternatively, the electric bus 504 can concurrently hook up with all 10 battery packs having a computer to decide the uses of the battery packs, such as taking electricity from all 10 battery packs concurrently or 5 battery packs a time. A person who has ordinary skill in the art would appreciate that there are many other ways to control the uses of the battery packs. In the case when the bus 504 is traveling from the bus stop two 518 to the bus stop three 520, 10 battery packs may not be sufficient for the electric bus 504 to travel the 110 km, so the battery store 506 and/or recharging station 514 is able to be established in between the bus stop two 518 and bus stop three 520. In some embodiments, the electric bus can carry a total of 12 battery packs to power it from bus stop two 518 to bus stop three 520. Having a calculated, estimated, or projected distance and weight that the bus needs to operate, the electric bus 504 is able to carry only the necessary numbers of battery packs.

The term “electric vehicles” (EV) used herein can include, but is not limited to, at least electric cars, electric trains, electric trucks, electric airplanes, electric boats, electric motorcycles and scooters, and electric spacecraft. The term “electric vehicles” disclosed herein is able to include battery electric vehicles (BEV). BEVs use chemical energy stored in rechargeable battery packs. The term “coasters” and “runners” used herein can include long bladelike strips of metal or wood on which a sled or sleigh slides, and a small mat or plate placed under a vessel.

The battery packs disclosed herein can be utilized in many ways to facilitate the modern urban life. For example, the battery packs allow an electric vehicle user to drag the battery packs like a suitcase along with them, providing a convenient way for the electric vehicle users to drag the battery packs home and have them recharged during the night at the regular AC power outlet on the wall of their house. The next morning, the electric vehicle users are able to drag or roll their battery packs to their electric vehicles and plug them to the mating connectors on the electric vehicles, all without physically lifting the battery packs. During the day, the battery packs are able to be recharged in the office or in the parking lot through one or more solar panels or AC/DC electric power sources.

As described above, the battery packs disclosed herein advantageously incorporate a ground transportation structure/device that allows the land to support substantially all of the weight of the battery packs during movement. In some embodiments, the battery packs and the ground transportation structure form an integrated unseparateable unit, so the risk of dropping or falling of the batteries is avoided.

The following description is presented to enable one of ordinary skill in the art to make and use the invention. Various modifications to the described embodiments will be readily apparent to those persons skilled in the art and the generic principles herein may be applied to other embodiments. Thus, the present invention is not intended to be limited to the embodiments shown but is to be accorded the widest scope consistent with the principles and features described herein. It will be readily apparent to one skilled in the art that other modifications may be made to the embodiments without departing from the spirit and scope of the invention as defined by the appended claims.

What is claimed is:

1. A movable battery pack comprising an electric-vehicle battery pack having a battery enclosure with a ground transporting structure rollable, slidable, or both along a surface.

2. The movable battery pack of claim 1, wherein the battery enclosure and the ground transporting structure are removable as a unit from an electric vehicle.

3. The movable battery pack of claim 1, wherein the electric-vehicle battery pack comprises a battery-electric-vehicle battery pack.

4. The movable battery pack of claim 1, wherein the ground transporting structure comprises one or more wheels.

5. The movable battery pack of claim 1, wherein the ground transporting structure comprises one or more coasters or runners.

6. The movable battery pack of claim 1, wherein the ground transporting structure is attached to the battery enclosure.

7. The movable battery pack of claim 1, wherein the electric-vehicle battery pack comprises one or more mating connectors.

8. The movable battery pack of claim 1, wherein the battery enclosure comprises at least one handle.

9. The movable battery pack of claim 1, wherein the electric-vehicle battery pack comprises one or more modules of batteries.

10. The movable battery pack of claim 1, wherein the one or more modules comprises one or more cells of batteries.

11. The movable battery pack of claim 1, wherein battery enclosure is configured to fit within a battery compartment of an electric vehicle.

12. The movable battery pack of claim 1, wherein the electric-vehicle battery pack and the ground transporting structure forms an unseparable energy unit.

13. An electric vehicle comprising:
a. a controller; and
b. one or more removable battery packs including a casing adapted to slide or roll along a surface.

14. The electric vehicle of claim 13, wherein the one or more removable battery packs comprise at least one handle.

15. The electric vehicle of claim 13, wherein the one or more removable battery packs comprise a mating connector.

16. The electric vehicle of claim 15, wherein the electric vehicle comprises a mating connector.

17. The electric vehicle of claim 16, wherein the mating connector of the electric vehicle is configured to electrically couple with the mating connectors of the one or more removable battery packs.

18. The electric vehicle of claim 13 further comprising a securing mechanism for substantially securing the one or more removable battery packs to the electric vehicle.

19. The electric vehicle of claim 18, wherein the securing mechanism couples with a mating connector of the electric vehicle, the one or more removable battery packs, or both.

20. The electric vehicle of claim 13, wherein the one or more removable battery packs comprise at least one wheel.

21. The electric vehicle of claim 13, wherein the one or more removable battery packs are rechargeable by an AC power source.

22. The electric vehicle of claim 13, wherein the electric vehicle is able to be operated using energy solely from one of the one or more removable battery packs.

23. A method of using an electric-vehicle battery pack comprising:
a. rolling, sliding, or both one or more ground transporting elements of an electric-vehicle battery pack along a surface; and
b. electrically coupling the electric-vehicle battery pack with an energy device.

24. The method of claim 23, wherein the one or more ground transporting elements comprise one or more wheels.

25. The method of claim 23, wherein the surface comprises a ground surface.

26. The method of claim 23, wherein the energy device comprises an electric vehicle, an electrical charger, or both.

27. The method of claim 26, wherein the electrically coupling comprising coupling a mating connector of the electric-vehicle battery pack with a mating connector of the electric vehicle.

28. The method of claim 23, wherein the rolling, sliding, or both are performed by holding at least one handle of the electric-vehicle battery pack.

29. The method of claim 23 further comprising disengaging the electric-vehicle battery pack from the energy device.

30. The method of claim 29 further comprising removing the electric-vehicle battery pack from the energy device.

31. The method of claim 29, wherein at least one of the ground transporting elements touch a ground surface when the ground transporting elements are transported.

32. The method of claim 29 further comprising recharging the electric-vehicle battery pack.

33. The method of claim 33, wherein the recharging is performed by using an AC power source.
